(19) United States
(12) Patent Application Publication
(10) Pub. No.: US 2009/0116414 A1
(43) Pub. Date: May 7, 2009

(54) Mass Viewer Audience Circuit Based Real Time Participation In Interactive Applications Displayed Live On Display Screens

(75) Inventors: Amit Or, Mishmeret (IL); Franck Malka, Kfar Yona (IL)

Correspondence Address: SEAN LIAM KELLEHER;Kelleher IP PLLC, 16 PECKSLIP RD, CARMEL, NY, 10512, US

(73) Assignee: INLIVE LTD., Ra'anana (IL)

(21) Appl. No.: 10/595,898

(22) PCT Filed: Nov. 18, 2004
(86) PCT No.: PCT/IL2004/001060

§ 371 Date: May 18, 2006

Related U.S. Application Data
(60) Provisional application No. 60/523,547, filed on Nov. 21, 2003.

(51) Int. Cl. H04L 5/14; H04L 12/56

(52) U.S. Cl. 370/276; 370/401

(57) ABSTRACT

The present invention is directed toward mass viewer audience circuit based real time participation in live TV shows, and other interactive applications displayed on electronic billboards, so-called vidiwalls, and the like. The present invention includes a Mass Viewer Audience Response Detection (MVARD) gateway for establishing inbound half duplex line connections with callers' telephones on receiving circuit based telephone calls therefrom for determining callers' DTMF key depressions corresponding to their real time responses to an interactive application, and transmitting real time information regarding the callers' responses for providing real time feedback to the mass viewer audience watching the interactive application, and particularly the callers continuously holding their telephones like a hand held TV remote control and depressing on the DTMF keys on their telephones to input their responses to actively participate therein without interrupting their participation to listen to pre-recorded playback messages regarding DTMF key assignments.

### BACKGROUND OF THE INVENTION

1. Field of the Invention

The invention relates to mass viewer audience participation in interactive applications displayed live on display screens.

2. Brief Summary of the Related Art

Mass viewer audience participation in interactive applications displayed live on display screens was until only recently restricted to home television viewers participating in live TV shows such as televoting phone-ins, game shows, and the like, as illustrated and described in U.S. Pat. No. 5,108,115 to Berman et al., U.S. Pat. No. 5,311,507 to Bedrossian, PCT International Publication No. WO 01/39854 entitled “A Method and System for Facilitating the Playing of a Game”, amongst others.

FIG. 1 shows a first generation communication platform for connecting callers' telephones to an application server via a public switch for facilitating their participation in a live TV show, for example, a televoting phone-in for voting for the Best Ever Rock Group. In one implementation, the live TV show displays a banner-like overlay with a callback telephone number, say, #333, whilst the TV show's presenters tell viewers watching the show the relevant Dual Tone Multi-Frequency (DTMF) key assignments, say, “PRESS #1 FOR THE BEATLES, PRESS #2 FOR THE ROLLING STONES, PRESS #3 FOR THE WHO.” The callers call the callback telephone number and press the appropriate DTMF key corresponding to their responses. In an alternative implementation, the banner-like overlay displays three different callback telephone numbers corresponding to the different choices, say, “CALL #333 TO VOTE FOR THE BEATLES, CALL #444 TO VOTE FOR THE ROLLING STONES, CALL #555 TO VOTE FOR THE WHO.”, and the TV show presenters tell the viewers watching the TV show when the telephone lines are open.

FIG. 2 shows a second generation communication platform for connecting callers' telephones to an application server via an Interactive Voice Response (IVR) for facilitating their participation in a live TV show. The IVR is largely intended to replace TV show presenters from having to tell viewers watching the TV show the DTMF key assignments. The IVR plays back pre-recorded playback messages to the callers in a similar manner as, for example, paying a utility bill. Thus, the IVR typically plays back a welcome playback message informing them that they are now participating in the live TV show, and instruction playback messages regarding the DTMF key assignments for indicating their responses. However, few, if any, callers watching a live TV show have the inclination to alternately listen to an instruction playback message regarding DTMF key assignments for indicating their responses and then depress the appropriate DTMF key(s) for more than a few instruction playback messages thereby negating that a caller would participate in a live TV show for more than a few minutes at a time.

Both the above communication platforms suffer from a high cost per port such that provisioning platforms capable of handling hundreds of thousands of simultaneous telephone calls arising, say, from the broadcasting a live TV show nationwide is prohibitively expensive. The downside of this is two fold: First, public switches and IVRs which deliberately have insufficient capacity to cope with the expected number of television viewers wishing to participate in a live TV show are deployed despite the fact many of the callers will face the frustrating experience of busy lines. And second, telephone lines are typically kept open for relatively long periods of time to accumulate a sufficient number of responses, thereby negating the possibility of real time mass television viewer audience interactivity.

### SUMMARY OF THE INVENTION

The present invention is directed towards mass viewer audience circuit based real time participation in interactive applications displayed live on televisions, electronic billboards, so-called vidiwalls, and the like. Interactive applications include inter alia live TV shows, online auctions, group buying campaigns, and the like. Whilst the present invention is particularly advantageous for handling literally hundreds of thousands of callers participating in a live TV show, it may also be readily scaled down for servicing smaller mass viewer audiences ranging from, say, tens of shoppers at a shopping mall, to thousands of spectators at a live spectator event, and the like.

Broadly speaking, the present invention is achieved by provisioning a Mass Viewer Audience Response Detection (MVARD) gateway for establishing low cost per port inbound half duplex line connections with members of a mass viewer audience wishing to participate in an interactive application. The MVARD gateway enables callers to watch an interactive application and simultaneously interact by continuously holding their telephones like a hand held TV remote control and depressing the appropriate DTMF keys to input their responses without having to listen to pre-recorded playback messages regarding DTMF key assignments, and determines the callers' DTMF key depressions corresponding to their responses for feedback purposes. The low cost per port facilitates the provisioning of communication platforms capable of servicing mass television viewer audiences of literally hundreds of thousands or even millions of viewers watching a live TV show and wishing to enjoy a true real time interactive experience.

In the case of a live TV show, feedback is preferably in the form of a running commentary by the TV show's presenter whereby the presenter can effectively hold a real time dialogue with the mass television viewer audience watching the TV show and in particular those members participating therein. Thus, the presenter may make comments, ask questions and verbally specify DTMF key assignments, for example, “PRESS #1 IF YOU AGREE AND PRESS #2 IF YOU DISAGREE” whilst callers “converse” by depressing the appropriate DTMF keys on their telephones for inputting their responses. The running commentary can also be accompanied by suitable overlays forming part of the format of a live TV show displaying the assignments of the DTMF numeric 0-9, the star * and the pound # keys for indicating callers' responses. In the event that a caller listens to his telephone whilst still connected to a callback telephone number, he would hear a silent outbound transmission except immediately after his connection in which he would preferably be temporarily connected to an IVR for hearing a welcome playback message confirming that he is participating in the interactive application and completing several questions for registration purposes for subsequent data processing purposes of the callers' responses to an interactive application. For example, callers may be asked their age, their sex, etc such that groups of callers can compete against each other, callers' responses can be displayed broken down by group, etc. For example, men can compete against women, responses can be broken down by age group, say, <25, 25-50, and >50, and the like.

In accordance with a first preferred embodiment of the present invention, the MVARD gateway is implemented as a circuit based MVARD gateway employing dedicated call control type digital telephony interface boards capable of establishing inbound half duplex line connections only, for example, as employed for prepaid calling card applications, international callback applications, and the like. These digital telephony interface boards are considerably less expensive than their counterparts supporting full duplex line connections as employed in a public switch, IVR, and the like, such that it is envisaged that a communication platform employing a circuit based MVARD gateway can be provisioned at about USD 50 per port as opposed to the USD 500 port in case of a circuit based IVR or USD 600 in the case of an IP based IVR.

In the case of the availability of an Intelligent Network (IN) platform, typically the Signaling System 7 (SS7) IN, in accordance with a second preferred embodiment of the present invention, the MVARD gateway can be implemented as a transaction based MVARD gateway for deployment as a SS7 Service Control Point (SCP) based on the notion that DTMF key depressions conventionally intended for SS7 signaling purposes can be employed as real time input to interactive applications. This approach entails the use of two features supported in the widely accepted ITU's standard Intelligent Network User's Guide for Capability Set 1 (04/94), ITU-T Recommendations Q.1219, the contents of which are incorporated herein by reference, as follows: First, Single Ended Calls, namely, the ability to terminate a single party call at a Service Switching Point (SSP). And second, Mid-Call Interruption, namely, the ability to report on pre-defined triggers during a telephone call. The transaction based MVARD gateway can be in the form of either a standalone SS7 SCP or an existing open standard SS7 SCP running additional software to fulfill the intended functionality in accordance with the present invention. The cost per port in the case of a transaction based MVARD gateway depends on the type of its inbound communication links as follows: about USD 10 per port for either a 64K SS7 link or a 2M SS7 HSL link, or USD 2.5 per port for a 10 MB SS7 Sigtran link.

### BRIEF DESCRIPTION OF THE SEVERAL VIEWS OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a schematic diagram showing a first generation communication platform for enabling mass television viewer participation in a live TV show;

FIG. 2 is a schematic diagram showing a second generation communication platform for enabling mass television viewer participation in a live TV show;

FIG. 3 is a schematic diagram showing a communication platform including a MVARD gateway in accordance with the present invention for enabling mass television viewer circuit based real time participation in live TV shows;

FIG. 4 is a schematic diagram of the MVARD gateway of FIG. 3;

FIG. 5 is a schematic diagram showing the steps for participating in an interactive application in accordance with the present invention in the case of a transaction based MVARD gateway;

FIG. 6 is a schematic diagram showing the steps for participating in an interactive application in accordance with the present invention in the case of a transaction based MVARD gateway and an IVR; and

FIG. 7 is a top level flow diagram of mass viewer audience circuit based real time participation in an interactive application.

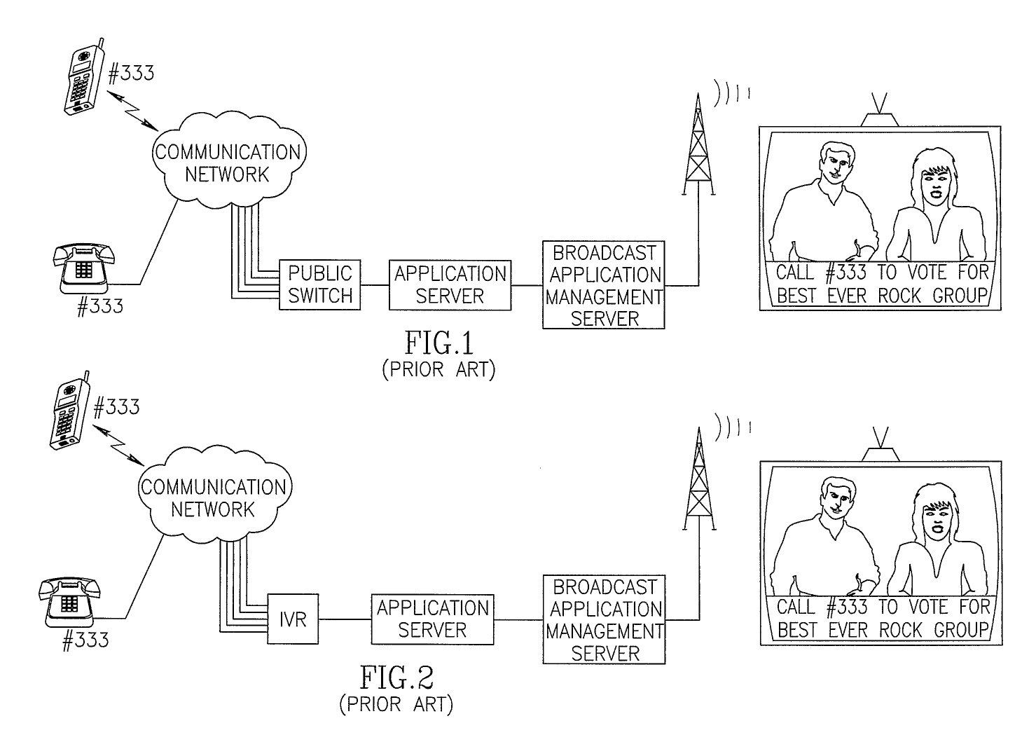

### DETAILED DESCRIPTION OF THE INVENTION

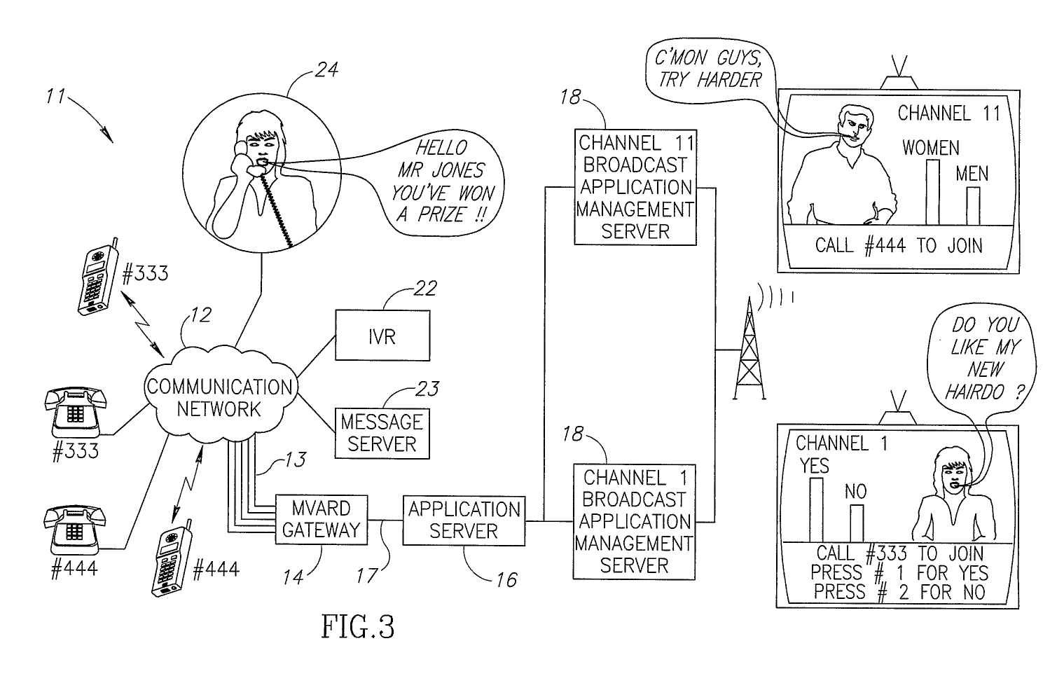

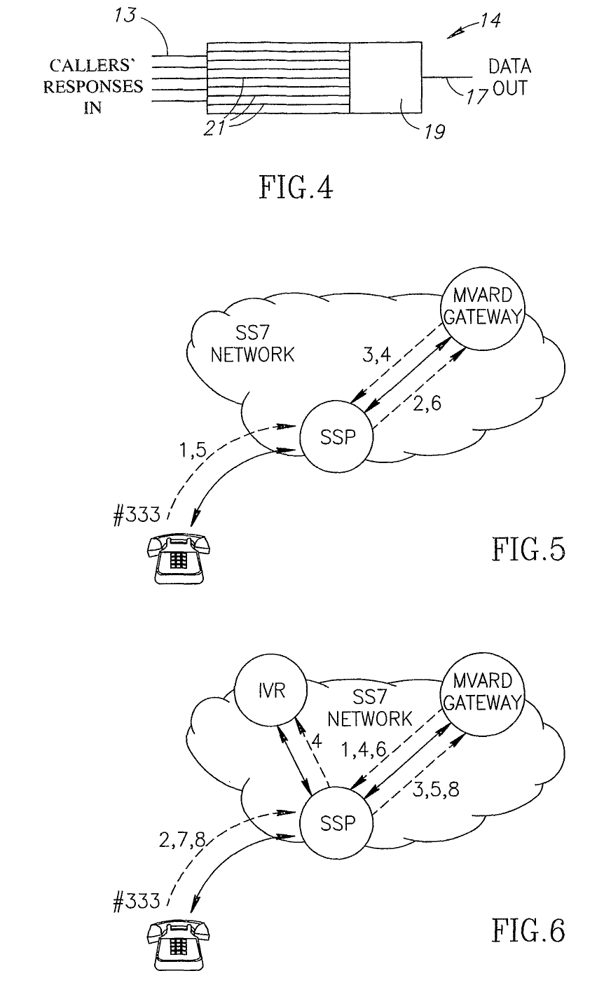

FIG. 3 shows a communication platform 11 including a communication network 12 having communication links 13 for connection to a Mass Viewer Audience Response Detection (MVARD) gateway 14 for transmitting IP digital information regarding callers' real time responses to an application server 16 connected over a TCP/IP data link 17 to broadcast application management servers 18 broadcasting two different live TV shows on TV channels 1 and 11. The MVARD gateway 14 includes a controller 19 for controlling digital telephony interface boards 21 for establishing inbound half duplex line connections with callers' telephones, and determining callers' DTMF key depressions corresponding to their responses to cues on the live TV shows (see FIG. 4). The MVARD gateway 14 can be implemented as a circuit based MVARD gateway or a transaction based MVARD gateway.

The communication platform 11 may also include an IVR 22 for, say, playing back a welcome playback message to callers placing telephone calls to participate in the live TV shows confirming that they are successfully participating, and for completing several questions for registration purposes for subsequent use in an interactive application. The communication platform 11 may also include a message server 23 for transmitting messages, for example, Class 0 SMSs for immediate display on callers' mobile telephones. Exemplary messages can include confirming that callers are now participating in a live TV show, callers who have won a prize, and the like. The communication platform 11 can also include a live operator 24 for initiating contact with a caller who, for example, won a prize by answering the most questions correctly in a televised quiz.

The MVARD gateway 14 is capable of transmitting Call Data Records (CDRs) for enabling billing of the telephone calls to participate in interactive applications to be invoiced by an external billing system. The MVARD gateway 14 is capable of interfacing with several interactive applications simultaneously as achieved, for example, by different callback telephone numbers being assigned to different interactive applications. The MVARD gateway 14 requires a smaller bandwidth IP data link 17 than hitherto available communication platforms since it typically transmits data packets in the order of 30 bytes per caller interaction.

Circuit based MVARD gateways 14 include digital telephony interface boards of the call control type for connecting to T1/E1 communication links 13, and dedicated for establishing inbound half duplex line connections. Suitable exemplary commercially available digital telephony interface boards of this type include inter alia Intel® NetStructure® DM/N960-T1 Digital Telephony Interface Boards (see http://www.intel.com/network/csp/products/7475web.htm for online datasheet as available on 16 Nov. 2004).

Transaction based MVARD gateways 14 include digital telephony interface boards of the transaction type supporting the aforementioned Single Ended Calls and Mid-Call Interruption features. Suitable exemplary commercially available digital telephony interface boards of this type include inter alia Intel® NetStructure® SS7HDP Boards (see http://www.intel.com/network/csp/products/9262web.htm for online datasheet as available on 16 Nov. 2004). The transaction based MVARD gateway 14 can be connected to different types of SS7 communication links 13 including inter alia 64K SS7 links, or 2M SS7 HSL links, or 10 MB SS7 Sigtran links, or the like.

FIG. 5 shows the following steps denoted by dashed arrows during a telephone call to a callback telephone number to participate in an interactive application in the case of a transaction based MVARD gateway:

Step 1: A member of a mass viewer audience dials a callback telephone number, say, #333, to participate in the interactive application.

Step 2: A SSP recognizes the callback telephone number and sends a query to the MVARD gateway.

Step 3: The MVARD gateway registers the caller and resets the timeout timer in the SSP so that the call is held in the SSP without being routed anywhere.

Step 4: The MVARD gateway requests that the SSP reports BCSM events of DTMF detection and call disconnection.

Step 5: Caller depresses a DTMF key to indicate his response to the interactive application.

Step 6: SSP recognizes the DTMF key depression and reports it to the MVARD gateway.

Steps 5 and 6 are repeated for as long as the caller is watching the interactive application and participating therein by depressing DTMF keys on his telephone.

Step 7: Caller drops the call whereupon the SSP reports the origination disconnection to the MVARD gateway.

FIG. 6 shows the following steps denoted by dashed arrows during a telephone call to a callback telephone number to participate in an interactive application in the case of a transaction based MVARD gateway and an IVR:

Step 1: MVARD gateway initiates service filtering at the SSP.

Step 2: A member of a mass viewer audience dials a callback telephone number, say, #333, to participate in the interactive application.

Step 3: SSP informs the MVARD gateway that specified service has been initiated.

Step 4: The MVARD gateway instructs the SSP to use the IVR to play a playback message to the caller and release the IP leg (the termination leg of the call only) once the playback message has finished.

Step 5: After the termination leg is dropped, SSP reports to the MVARD gateway.

Step 6: The MVARD gateway initiates the SSP for reporting DTMF and origination disconnection.

Step 7: Callers are kept connected to a single leg call to the SSP and the SSP reports to the MVARD gateway each time a DTMF is detected from the origination point.

Step 7 is repeated for as long as the caller is watching the interactive application and participating therein by depressing DTMF keys on his telephone.

Step 8: Caller drops the call whereupon the SSP reports the origination disconnection to the MVARD gateway.

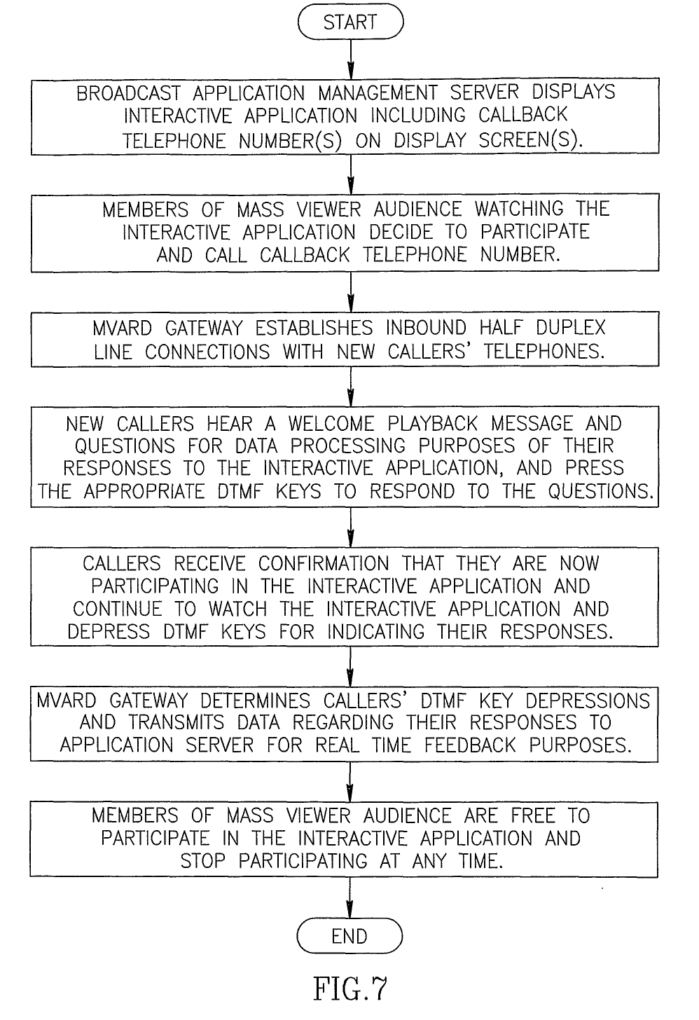

Mass television viewer circuit based real time participation in a live TV show hosted by Britney Spears on Channel 1 is now described with reference to FIG. 7. Members of the mass television viewer audience watching Channel 1 decide to participate in Britney Spear's live TV show, and call the callback telephone number #333 appearing in the overlay at the bottom of their TV screens. The callers connect to an IVR and hear a welcome playback message and are asked to answer a few short questions for use in processing their responses as follows: “HELLO. YOU HAVE CALLED THE BRITNEY SPEAR'S LIVE TV SHOW. PLEASE ANSWER THE FOLLOWING TWO SHORT QUESTIONS: PRESS #1 IF YOU ARE MALE AND #2 IF YOU ARE FEMALE. The callers press #1 or #2 accordingly. The IVR continues “PLEASE PRESS #1 IF YOU ARE UNDER 25, PRESS #2 IF YOU ARE BETWEEN THE AGES OF 25 AND 50, AND PRESS #3 IF YOU ARE OVER 50”. The callers press #1, #2 or #3 accordingly. The IVR responds “THANK YOU. YOU ARE NOW PARTICIPATING IN BRITNEY SPEAR'S LIVE TV SHOW. ENJOY!!”. The callers stop listening to their telephones and hold them as if they were TV remote controls. The callers continue watching the live TV show and respond to cues on the live TV show by depressing on the DTMF keys. For example, Britney can ask “HEY GUYS. DO YOU LIKE MY NEW HAIRDO?. Callers can respond by pressing #1 for YES or #2 for NO depending on their taste and their responses are included with the responses of possibly millions of other callers for showing on histograms, or being commented on by Britney, etc. Britney can respond: “WOW!! THANKS GUYS !! THAT'S REALLY GREAT SINCE I WAS KINDA WORRIED”. Britney can continue: “I WAS THINKING OF RELEASING A NEW SONG ABOUT MY LAST BOYFRIEND. DO YOU THINK I SHOULD?” Again callers can respond by pressing #1 for YES or #2 for NO depending on their opinion. This type of real time dialogue can continue for, say, an entire hour long live TV show. Members of the mass television viewer audience are free to participate in the live TV show and stop participating at any time.

While the invention has been described with respect to a limited number of embodiments, it will be appreciated that many variations, modifications, and other live applications of the invention can be made within the scope of the appended claims.

1. A Mass Viewer Audience Response Detection (MVARD) gateway for providing real time feedback to an interactive application displayed live on at least one display screen together with at least one callback telephone number for enabling members of a mass viewer audience watching the interactive application and calling a callback telephone number of the at least one callback telephone number to actively participate therein, the MVARD gateway comprising a controller for controlling at least one digital telephony interface board to establish inbound half duplex line connections with callers' telephones on receiving circuit based telephone calls therefrom for determining callers' DTMF key depressions corresponding to their real time responses to the interactive application, and transmitting real time information regarding callers' responses for providing real time feedback to the mass viewer audience watching the interactive application, and particularly the callers continuously holding their telephones like a hand held TV remote control and depressing the DTMF keys on their telephones to input their responses to actively participate therein without interrupting their participation to listen to pre-recorded playback messages regarding DTMF key assignments.

2. The gateway according to claim 1 constituted by a circuit based MVARD gateway including at least one call control type digital telephony interface board for establishing said inbound half duplex line connections and detecting callers' DTMF key depressions.

3. The gateway according to claim 1 constituted by a transaction based MVARD gateway for deployment as a Service Control Point (SCP) in an Intelligent Network (IN), said transaction based MVARD gateway including at least one transaction type digital telephony interface board supporting Single Ended Calls and Mid-Call Interruption features for establishing said inbound half duplex line connections and issuing queries for determining callers' DTMF key depressions.

4. The gateway according to claim 3 wherein said transaction based MVARD gateway is a standalone SCP.

5. The gateway according to claim 3 wherein said transaction based MVARD gateway is an open standard SCP.

6. A communication platform for enabling mass viewer audience circuit based real time participation in an interactive application displayed live on at least one display screen, the platform comprising:
(a) an application server for providing real time feedback to an interactive application displayed live on at least one display screen together with at least one callback telephone number for enabling members of a mass viewer audience watching the interactive application to call a callback telephone number of the at least one callback telephone number to actively participate therein; and
(b) a Mass Viewer Audience Response Detection (MVARD) gateway on receiving circuit based telephone calls from callers' telephones, establishing inbound half duplex line connections with callers' telephones for determining callers' DTMF key depressions corresponding to their real time responses to the interactive application, and transmitting real time information regarding the callers' responses to said application server for providing real time feedback to the mass viewer audience watching the interactive application, and particularly the callers continuously holding their telephones like a hand held TV remote control and depressing on the DTMF keys on their telephones to input their responses to actively participate therein without interrupting their participation to listen to pre-recorded playback messages regarding DTMF key assignments.

7. The platform according to claim 6 wherein said MVARD gateway is constituted by a circuit based MVARD gateway including at least one call control type digital telephony interface board for establishing said inbound half duplex line connections and detecting callers' DTMF key depressions.

8. The platform according to claim 6 wherein said MVARD gateway is constituted by a transaction based MVARD gateway for deployment as a Service Control Point (SCP) in an Intelligent Network (IN), said transaction based MVARD gateway including at least one transaction type digital telephony interface board supporting Single Ended Calls and Mid-Call Interruption features for establishing said inbound half duplex line connections and issuing queries for determining callers' DTMF key depressions.

9. The platform according to claim 8 wherein said transaction based MVARD gateway is a standalone SCP.

10. The platform according to claim 8 wherein said transaction based MVARD gateway is an open standard SCP.

11. The platform according to any one of claims 6 to 10 and further comprising an IVR for selectively playing back pre-recorded playback messages to callers including a welcome playback message confirming that they are participating in the interactive application which they called.

12. The platform according to claim 11 wherein said IVR plays back pre-recorded questions to callers whose responses thereto are employed for data processing purposes of their responses to the interactive application.

13. The platform according to any one of claims 6 to 12 and further comprising a message server for selectively transmitting visual messages to callers' telephones.

14. A method for enabling mass viewer audience circuit based real time participation in an interactive application displayed live on at least one display screen, the method comprising the steps of:
(a) displaying an interactive application live on at least one display screen together with at least one callback telephone number for enabling members of a mass viewer audience watching the interactive application to call a callback telephone number of the at least one callback telephone number to actively participate therein;
(b) on receiving circuit based telephone calls from callers' telephones, establishing inbound half duplex line connections with callers' telephones for determining callers' DTMF key depressions corresponding to their real time responses to the interactive application; and
(c) transmitting real time information regarding callers' responses for providing real time feedback to the mass viewer audience watching the interactive application, and particularly the callers continuously holding their telephones like a hand held TV remote control and depressing the DTMF keys on their telephones to input their responses to actively participate therein without interrupting their participation to listen to pre-recorded playback messages regarding DTMF key assignments.

15. The method according to claim 14 wherein the MVARD gateway is constituted by a circuit based MVARD gateway including at least one call control type digital telephony interface board for establishing the inbound half duplex line connections and detecting callers' DTMF key depressions.

16. The method according to claim 14 wherein the MVARD gateway is constituted by a transaction based MVARD gateway for deployment as a Service Control Point (SCP) in an Intelligent Network (IN), said transaction based MVARD gateway including at least one transaction type digital telephony interface board supporting Single Ended Calls and Mid-Call Interruption features for establishing the inbound half duplex line connections and issuing queries for determining callers' DTMF key depressions.

17. The method according to claim 16 wherein said transaction based MVARD gateway is a standalone SCP.

18. The method according to claim 16 wherein said transaction based MVARD gateway is an open standard SCP.

19. The method according to any one of claims 14 to 18 and further comprising the step of selectively playing back pre-recorded playback messages to callers including a welcome playback message confirming that they are participating in the interactive application which they called.

20. The method according to claim 19 and further comprising the step of playing back pre-recorded questions to callers whose responses thereto are employed for data processing purposes of their responses to the interactive application.

21. The method according to any one of claims 14 to 20 and further comprising the step of selectively transmitting visual messages to callers' telephones.
